(19) United States
(12) Patent Application Publication
(10) Pub. No.: US 2008/0174354 A1
(43) Pub. Date: Jul. 24, 2008

(54) CLOCK GENERATING CIRCUIT AND METHOD THEREOF

(75) Inventors: Kuo-Cheng Yu, Hsinchu city (TW); Tyng-Yuan Luh, Kaohsiung City (TW)

Correspondence Address: WPAT, PC, 7225 BEVERLY ST., ANNANDALE, VA, 22003, US

(73) Assignee: HOLTEK SEMICONDUCTOR INC., Hsinchu (TW)

(21) Appl. No.: 11/757,497

(22) Filed: Jun. 4, 2007

(30) Foreign Application Priority Data
Jan. 23, 2007 (TW) 096102428

(51) Int. Cl. G06F 1/04

(52) U.S. Cl. 327/298

(57) ABSTRACT

A clock generating circuit and method therefor are provided, which includes a control unit, a first oscillating module, a second oscillating module, a status control unit, and a multiplexer. The control unit is used for outputting a first control signal and a second control signal so as to drive the first oscillating module and the second oscillating module to generate or stop from a first clock signal and a second signal to the multiplexer. The status control unit is used for judging whether the second clock signal approaches a stable state, for controlling the multiplexer to output selectively the first clock signal or the second clock signal so as to maintain the stable state of a clock outputting by the multiplexer for all the time

### BACKGROUND OF THE INVENTION

1. Field of Invention

The present invention relates to a clock generating circuit and method therefor, and more particularly, to a circuit and a method for generating a clock signal applied to a liquid crystal display (LCD).

2. Related Art

LCD approaches a low power consumption mode when the LCD enters a halt mode, sleep mode, power-down mode or standby mode. In order of saving power, a basic function and monitor action of a display driver IC or micro-controller still maintain their performance, for being capable of a judging control function executed by outer control system, so that performances of other non-basic circuits are delayed.

As shown in FIG. 1, which is a block diagram of a clock generating circuit and a display driver of a prior art LCD. The prior art clock generating circuit includes an LCD driver 10a and a crystal oscillator 50a. The LCD driver 10a is used to drive LCD to operate, and the crystal oscillator 50a is regarded as an element for outputting a stable frequency in a timer circuit. An oscillator frequency is outputted by the crystal oscillator 50a to the LCD driver 10a, and the LCD may be driven when the oscillator frequency is received by the LCD driver 10a. The LCD enters the halt mode for maintaining a low power consumption status when the system outputs a halt signal to the crystal oscillator 50a so that the crystal oscillator 50a is delayed to operate without outputting the oscillator frequency.

The system exits from the halt mode and enters an operation mode, so that outputs a wake-up signal to the crystal oscillator 50a for being used to restart when the system is affected by an inner setting of the system, a hardware behavior of a peripheral component or a user. However, it takes quite a lot of operating time from a vibration-generating mode to the clock approaching a stable mode. Furthermore, the frequency of the crystal oscillator 50a lies in an unstable mode before the clock approaches the stable mode. Once the LCD driver 10a receives the unstable clock, and the operation frequency of the LCD driver 10a is unable to stable, so that LCD generates an improper message or a display image may abnormally appear. The LCD may be capable of operating normally until the oscillator frequency of the crystal oscillator 50a is stable. In this manner, the user takes a lot of time to wait a operating of the LCD and result in inconvenience of the user.

### SUMMARY OF THE INVENTION

According to the above prior art, the frequency of the crystal oscillator lies in a vibration-generating mode before the clock approaches the stable mode, as a result, the LCD generates an improper message or the display image can not normally appear, which is time-consuming, and the user waits for display image back to normal. In view of this, an object of the present invention is to provide a clock generating circuit and method therefor, which can solve above problems.

In order to achieve the above object, the present invention provides a clock generating circuit, which includes a control unit, a first oscillating module, a second oscillating module, a status control unit, and a multiplexer. The control unit has a first signal receiving end and a second signal receiving end, wherein the first signal receiving end is used for receiving a transmission signal, the second signal receiving end is used for receiving a third control signal and the control unit is used for outputting a first control signal and a second control signal. The first oscillating module is used to receive the first control signal, for outputting or stopping from generating a first clock signal in accordance with the first control signal lying in an enable status or a disable status. The second oscillating module is used to receive the second control signal, for outputting or stopping from generating a second clock signal in accordance with the second control signal lying in an enable status or a disable status. The status control unit is used to receive the second clock signal, and output the third control signal that is a non-stationary or a stationary signal, for controlling the control unit. The multiplexer is used to receive the first clock signal and the second clock signal, and selectively output the first clock signal or the second clock signal in accordance with the received third control signal. Furthermore, a vibration generating velocity of the first oscillating module is faster than that of the second oscillating module, and a frequency error of the first clock signal is larger than that of the second clock signal.

In order to achieve the above object, the present invention further provides a clock generating method, which includes a transmission signal received by a first signal receiving end of a control unit and a third control signal received by a second signal receiving end of the control unit, for outputting a first control signal and a second control signal. The first control signal is received by a first oscillating module, for outputting or stopping from generating a first clock signal in accordance with the first control signal lying in an enable status or a disable status. The second control signal is received by a second oscillating module, for outputting or stopping from generating a second clock signal in accordance with the second control signal lying in an enable status or a disable status. The second clock signal is received by a status control unit, for outputting the third control signal comprising a non-stationary signal and a stationary signal, and after performing above step, the first clock signal and the second clock signal received by a multiplexer, for outputting selectively the first clock signal or the second clock signal in accordance with the received third control signal, wherein a vibration-generating velocity of the first oscillating module is faster than that of the second oscillating module, and a frequency error of the first clock signal is larger than that of the second clock signal.

In order to achieve the above object, the present invention further provides a control method of a clock generating circuit with a control unit, which includes entering a halt mode when a halt signal is received by the control unit for outputting a first control signal with a disable status and a second control signal with a disable status so as to let a third control signal to be a non-stationary signal. The control unit enters a vibration-generating mode when the control unit receives a wake-up signal for outputting the first control signal with the enable status and the second control signal with the enable status so as to let the third control signal to be a non-stationary signal. The control unit enters a stabilization mode, and meanwhile, the third control signal being the stationary signal for outputting the first control signal with the disable status and the second control signal with the enable status.

According to the clock generating circuit and the clock generating method disclosed by the present invention, the effect lies in that:

Firstly, the LCD exits by the halt mode and enters an operation mode so that the LCD receives normal operation clock. Therefore, the clock fast approaches the stable mode so as to reduce waiting time of the display image of the LCD.

Secondly, a stable clock is provided by the first oscillating module and the second oscillating module, so as to avoid generating the abnormal phenomenon of the display image caused by the LCD.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a block diagram of a clock generating circuit and a display driver of a prior art LCD;

FIG. 2 is a block diagram of a clock generating circuit according to one embodiment of the present invention;

FIG. 3 is a flow chart of the clock generating method according to one embodiment of the present invention;

FIG. 4 is an operating diagram of a control unit receiving a halt signal in the clock generating circuit according to one embodiment of the present invention;

FIG. 5 is an operating diagram of a multiplexer outputting a first clock signal in the clock generating circuit when a control unit received wake-up signal according to one embodiment of the present invention;

FIG. 6 is an operating diagram of a second clock signal approaching a stable status in the clock generating circuit when the control unit received wake-up signal according to one embodiment of the present invention;

FIG. 7 is a schematic view of the operation of the clock generating circuit with a control unit according to one embodiment of the present invention; and

FIG. 8 is a timing diagram of the clock generating circuit according to one embodiment of the present invention.

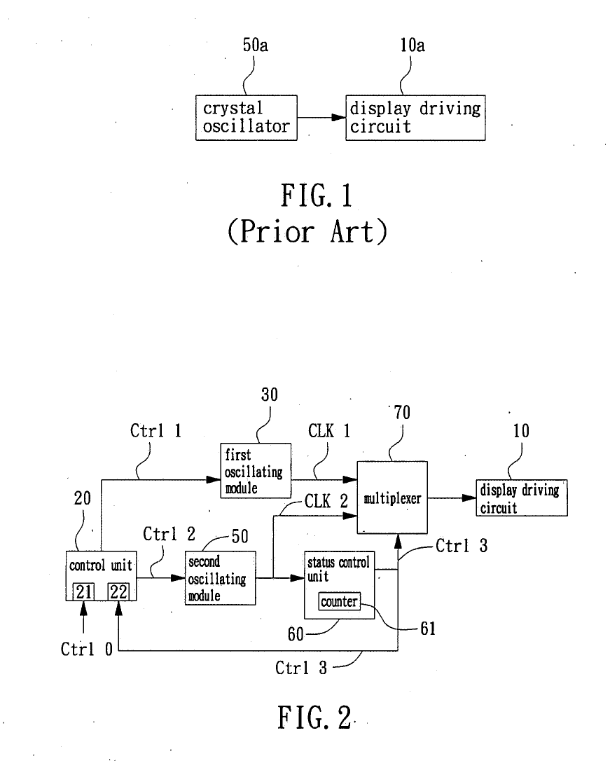

### DETAILED DESCRIPTION OF THE INVENTION

In order to further understand the objective, construction, feature, and function of the present invention, it is described below in great detail through the embodiments.

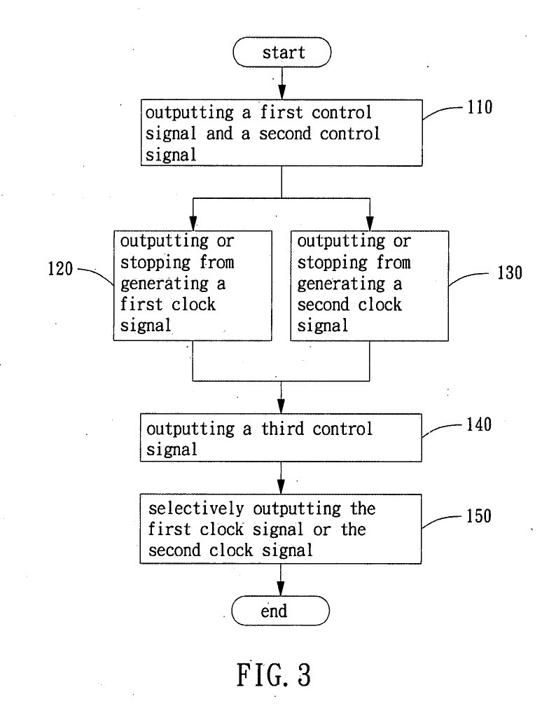

FIG. 2 is a block diagram of a clock generating circuit according to one embodiment of the present invention. The clock generating circuit includes a control unit 20, a first oscillating module 30, a second oscillating module 50, a status control unit 60 and a multiplexer 70, which is applied to an LCD, but not limited to the LCD. FIG. 3 is a flow chart of the clock generating method according to one embodiment of the present invention, which includes outputting a first control signal and a second control signal (step 110), outputting or stopping from generating a first clock signal (step 120), outputting or stopping from generating a second clock signal (step 130), outputting a third control signal (step 140), and selectively outputting the first clock signal or the second clock signal (step 150). The principle of the clock generating circuit applied to the LCD of the present invention will be illustrated below through the following embodiments.

With regard to the principle the clock generating circuit applied to the LCD of the present invention, referring to FIG. 2, a clock signal generated by the first oscillating module 30 and the second oscillating module 50 is used for driving the LCD to operate when the LCD driver 10 receives the clock signal. Then, each element is described below through the embodiments.

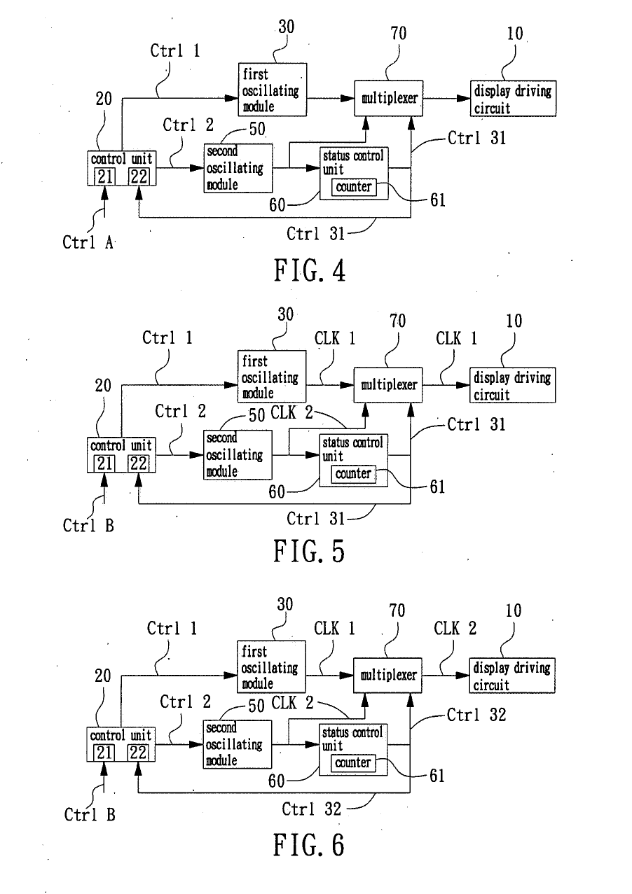

The control unit 20 has a first signal receiving end 21 and a second signal receiving end 22, wherein the first signal receiving end 21 is used to receive a generated transmission signal Ctrl0 including a halt signal CtrlA and a wake-up signal CtrlB generated by a system (as shown in FIGS. 4, 5 and 6). The halt signal CtrlA generated by the system is used for driving the LCD to enter a halt mode, so as to maintain a low power consumption status. The wake-up signal CtrlB used to drive the LCD to enter an operation mode is provided for user to operate.

The second signal receiving end 22 is used to receive the third control signal Ctrl3 that is a non-stationary signal Ctrl31 or a stationary signal Ctrl32 generated by the status control unit 60, for controlling the operation of the control unit 20. The control unit 20 is used to output the first control signal Ctrl1 and the second control signal Ctrl2 to the first oscillating module 30 and the second oscillating module 50 when the transmission signal Ctrl0 or the third control signal Ctrl3 is received by the control unit 20. The first control signal Ctrl1 with a disable status and an enable status is used to control the operation of the first oscillating module 30, and the second control signal Ctrl2 with a disable status and an enable status is used to control the operation of the second oscillating module 50.

The first oscillating module 30 is a RC oscillating module. That is, a frequency selection of a circuit only composed of a capacitor and a resistor in the circuit frequency selection, and it is not limited to this. For example, the first oscillating module 30 is a circuit module that can generate periodic wave may also be applied in the present invention. In addition, the first oscillating module 30 is used for receiving the first control signal Ctrl1, for outputting or stopping from generating a first clock signal CLK1 in accordance with the first control signal Ctrl1 lying in the enable status or the disable status.

The second oscillating module 50 is a crystal oscillating module, which is formed with a crystal, and it is not limited to this. In addition, the second oscillating module 50 is used for receiving the second control signal Ctrl2, for outputting or stopping from generating a second clock signal CLK2 in accordance with the second control signal Ctrl2 lying in the enable status or the disable status.

The vibration-generating velocity of the first oscillating module 30 is faster, but the frequency error of the first oscillating module 30 is larger. However, the vibration-generating velocity of the second oscillating module 50 is slower, but the frequency error of the second oscillating module 50 is more accurate. In order to maintain the stable state of the clock signal generated by the first oscillating module 30 or the second oscillating module 50 during the vibration-generating mode to the stable mode, the first clock signal CLK1 is set to lie in between a reference range of the second clock signal CLK2. For example, the frequency of the first clock signal CLK1 is larger than or equal to 80 percent of a frequency of the second clock signal CLK2, and is less than or equal to 120 percent of the frequency of the second clock signal CLK2. Herein, the frequency of the first clock signal CLK1 is equal to the frequency of the second clock signal CLK2 in the embodiment of the present invention, so as to maintain consistency of the clock signal.

The status control unit 60 is used for receiving the second clock signal CLK2, and outputting the third control signal Ctrl3. Also, in order to count a time of the second clock signal approaching the stable state, the status control unit 60 includes a counter 61 for counting time.

The time of the second clock signal CLK2 approaching the stable state is obtained by experience value, experiment value, simulation value and various data, so that the status control unit 60 may predetermine a reference time in accordance with above data. The counter 61 starts to count while the second clock signal CLK2 is received by the status control unit 60 until it is approaching the reference time, and the counter 61 stops to count for transmitting signal to drive the status control unit 60 to output the third control signal Ctrl3.

In addition, the status control unit 60 outputs the non-stationary signal Ctrl31 before the frequency of the second clock signal CLK2 reaching the stable state, and the status control unit 60 outputs the stationary signal Ctrl32 after the frequency of the second clock signal CLK2 approaching the stable state.

Then, the multiplexer 70 is used for receiving a plurality of signals, and judging one of the signals in the input end to be read in accordance with a value of the signal. Herein, the multiplexer 70 is used for receiving the first clock signal CLK1 and the second clock signal CLK2, and selectively outputting the first clock CLK1 or the second clock signal CLK2 in accordance with the received third control signal Ctrl3.

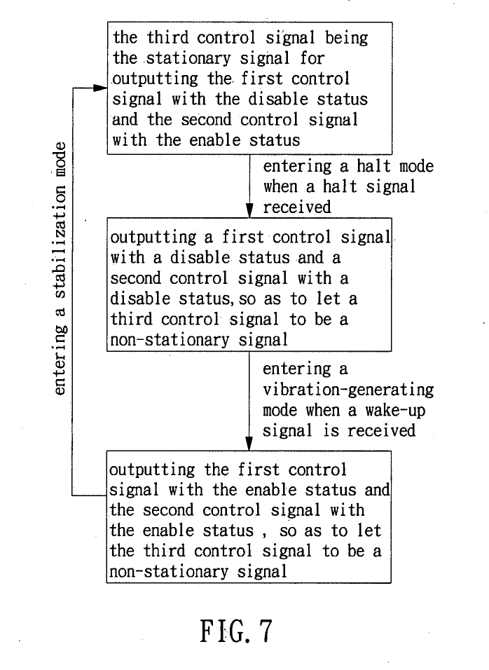

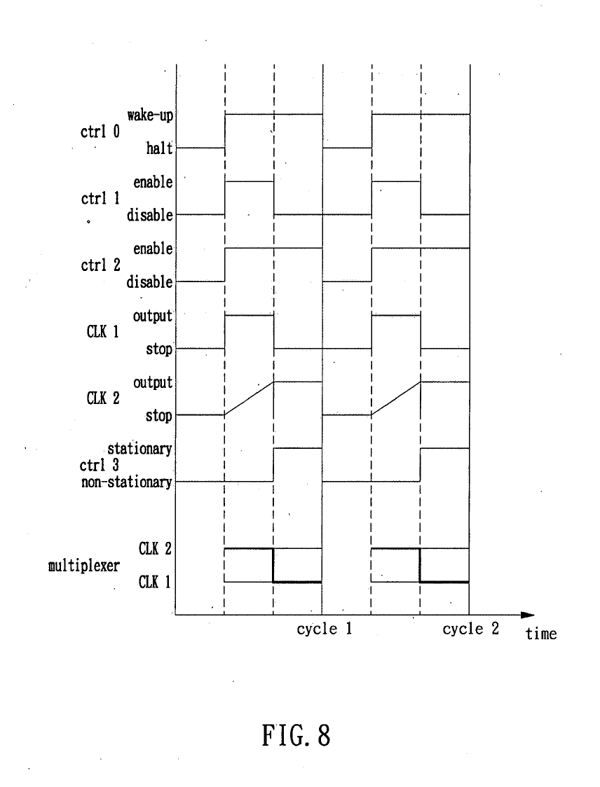

FIG. 4 is an operating diagram of a control unit receiving a halt signal in the clock generating circuit according to one embodiment of the present invention. FIG. 5 is an operating diagram of a multiplexer outputting a first clock signal in the clock generating circuit when a control unit received wake-up signal according to one embodiment of the present invention. FIG. 6 is an operating diagram of a second clock signal approaching a stable status in the clock generating circuit when the control unit received wake-up signal according to one embodiment of the present invention. FIG. 7 is a schematic view of the operation of the clock generating circuit with a control unit according to one embodiment of the present invention. FIG. 8 is a timing diagram of the clock generating circuit according to one embodiment of the present invention. Furthermore, as shown in FIG. 7, the operation of the control unit lying in the halt mode, vibration-generating mode and stabilization mode is shown. The control unit enters the halt mode when the halt signal is received for outputting the first control signal with lying in a disable status and the second control signal with lying in a disable status, so as to drive the third control signal to be the non-stationary signal. The control unit enters the vibration-generating mode when the wake-up signal is received for outputting the first control signal with lying in the enable status and the second control signal with lying in the enable status, so as to let the third control signal to be the non-stationary signal. The control unit enters the stabilization mode, and meanwhile, the third control signal is a stationary signal, for outputting the first control signal with lying in the disable status and the second control signal with lying in the enable status. Then, each operation state of the embodiments is described.

The operation state of the halt mode is described, referring to FIGS. 2, 4, 7 and 8. Since the system enters the halt mode because of an inner setting or resting for a long time, the system transmits the halt signal CtrlA to the first signal receiving end 21 for driving a whole circuit to enter the halt mode. After the receiving process, the control unit 20 drives to the first control signal Ctrl1 and the second control signal Ctrl2 to lie in the disable status. Then, the first oscillating module 30 and the second oscillating module 50 stop from generating the first clock signal CLK1 and the second clock signal CLK2, i.e. without any clock signal generating.

Since the second oscillating module 50 stops from generating the second clock signal CLK2, the status control unit 60 is incapable of receiving the second clock signal CLK2. Therefore, the status control unit 60 outputs the non-stationary signal Ctrl31 to the multiplexer 70 and the second signal receiving end 22 of the control unit 20. In addition, since the multiplexer 70 is incapable of receiving the first clock signal CLK1 and the second clock signal CLK2, so that the multiplexer 70 is incapable of outputting a signal to the LCD driver 10.

The operation state of the vibration-generating mode is described, referring to FIGS. 5, 7 and 8. The system exits from the halt mode and enters an operation mode when the system is affected by an inner setting of the system, a hardware behavior of a peripheral component or a user, so that transmits a wake-up signal CtrlB to the first signal receiving end 21. Then, the control unit 20 receives the wake-up signal CtrlB for driving the first control signal Ctrl1 and the second control signal Ctrl2 to lie in the enable status. Furthermore, after receiving the above control signals, the first oscillating module 30 and the second oscillating module 50 is used for generating the first clock signal CLK1 and the second clock signal CLK2 respectively which are transmitted to the multiplexer 70.

In order to count a time of the second clock signal approaching the stable state when the status control unit 60 receives the second clock signal CLK2, the counter 61 starts to count and transmit the signal, for driving the status control unit 60 to output the non-stationary signal Ctrl31 to the second signal receiving end 22 and multiplexer 70. At this point, the multiplexer 70 selects to output the first clock signal CLK1 to the LCD driver 10 in accordance with the non-stationary signal Ctrl31 after the multiplexer 70 receives the first clock signal CLK1 and the second clock signal CLK2.

Also, the second clock signal CLK2 approaches the stable mode from the vibration-generating mode, which is time-consumption, and lies in unstable during the period. However, the vibration-generating velocity of the first oscillating module 30 is faster than that of the second oscillating module 50, and the frequency error of the first clock signal CLK1 is larger than that of the second clock signal CLK2, so that the first clock signal CLK1 is regarded as a operation frequency of the LCD driver 10, and the second clock signal CLK2 is regarded as its operation frequency by the time the second clock signal CLK2 approaching the stable state.

The operation state of the stabilization mode is described, referring to FIGS. 6, 7 and 8. If the reference time is reached after the second oscillating module 50 outputting the second clock signal CLK2, and then the counter 61 stops to count for transmitting the signal. The status control unit 60 outputs the stationary signal Ctrl32 to the second signal receiving end 22 and the multiplexer 70 in accordance with the result that the second clock signal CLK2 approaches the stable state.

When the control unit 20 receives the stationary signal Ctrl32, the first control signal Ctrl1 lies in the disable status but the second control signal Ctrl2 still lies in the enable status. Therefore, the first oscillating module 30 stops from generating the first clock signal Ctrl1, and the second oscillating module 50 outputting the second clock signal CLK2. Accordingly, the multiplexer 70 selectively outputs the second clock signal CLK2 to the LCD driver 10 in accordance with the stationary signal Ctrl32, so that the LCD normally operate in the operation mode.

If the system enters the halt mode since the system is affected by the inner setting or resting for a long time, then the system is operated according to the above steps, and will not be further described.

All the mentioned as above, the vibration-generating velocity of the first oscillating module is faster. On the other hand, the vibration-generating velocity of the second oscillating module 50 is slower than that of the first oscillating module, but the outputting frequency of the second oscillating module is more accurate than that of the first oscillating module. The first oscillating module can generate the clock for providing the LCD driver to receive first when the system enters the operation mode from the halt mode. Furthermore, the first oscillating module stops from generating the clock when the frequency of the second oscillating module approaches the stable state, and then the LCD driver receives the clock generated by the second oscillating module, so that the operation clock of the LCD driver may lie in a maintaining stability.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A clock generating circuit, comprising:
a control unit, having a first signal receiving end and a second signal receiving end, wherein the first signal receiving end for receiving a transmission signal, the second signal receiving end for receiving a third control signal and the control unit for outputting a first control signal and a second control signal;
a first oscillating module, used for receiving the first control signal, for outputting or stopping from generating a first clock signal in accordance with the first control signal lying in an enable status or a disable status;
a second oscillating module, used for receiving the second control signal, for outputting or stopping from generating a second clock signal in accordance with the second control signal lying in an enable status or a disable status;
a status control unit, used for receiving the second clock signal, and outputting the third control signal that being a non-stationary signal or a stationary signal, for controlling the control unit; and
a multiplexer, used for receiving the first clock signal and the second clock signal, and selectively outputting the first clock signal or the second clock signal in accordance with the received third control signal;
wherein a vibration-generating velocity of the first oscillating module is faster than that of the second oscillating module, and a frequency error of the first clock signal is larger than that of the second clock signal.

2. The clock generating circuit as claimed in claim 1, wherein the first oscillating module is a RC oscillating module.

3. The clock generating circuit as claimed in claim 1, wherein the second oscillating module is a crystal oscillating module.

4. The clock generating circuit as claimed in claim 1, wherein a frequency of the first clock signal is larger than or equal to 80 percent of a frequency of the second clock signal, and is less than or equal to 120 percent of the frequency of the second clock signal.

5. The clock generating circuit as claimed in claim 1, wherein the frequency of the first clock signal is equal to the frequency of the second clock signal.

6. The clock generating circuit as claimed in claim 1, wherein the transmission signal received by the first signal receiving end further comprises a halt signal and a wake-up signal.

7. The clock generating circuit as claimed in claim 1, wherein the status control unit comprises a counter.

8. The he clock generating circuit as claimed in claim 6, wherein the control unit drives the first control signal and the second control signal to lie in the disable status for driving the first oscillating module and the second oscillating module to stop from generating respectively the first clock signal and the second clock signal when the first signal receiving end receives the halt signal.

9. The he clock generating circuit as claimed in claim 8, wherein the status control unit outputs the non-stationary signal to the second signal receiving end and the multiplexer, for driving the multiplexer to be incapable of outputting signal.

10. The he clock generating circuit as claimed in claim 6, wherein the control unit drives the first control signal and the second control signal to lie in the enable status for driving the first oscillating module and the second oscillating module to generating the first clock signal and the second clock signal when the first signal receiving end receives the wake-up signal respectively.

11. The he clock generating circuit as claimed in claim 10, wherein the multiplexer selects to output the first clock signal when the status control unit outputs the non-stationary signal to the second signal receiving end and the multiplexer.

12. The he clock generating circuit as claimed in claim 10, wherein the status control unit outputs the stationary signal to the second signal receiving end and the multiplexer when the second clock signal approach a stable state.

13. The he clock generating circuit as claimed in claim 12, wherein the control unit drives the first control signal to lie in the disable status for driving the first oscillating module to stopping from generating the first clock signal, and the multiplexer outputs the second clock signal in accordance with the stationary signal.

14. A clock generating method, comprising steps of:
outputting a first control signal and a second control signal, for which a transmission signal is received by a first signal receiving end of a control unit and a third control signal is received by a second signal receiving end of the control unit;
outputting or stopping from generating a first clock signal in accordance with the first control signal lying in an enable status or a disable status, for which the first control signal is received by a first oscillating module;
outputting or stopping from generating a second clock signal in accordance with the second control signal lying in an enable status or a disable status, for which the second control signal received by a second oscillating module;
outputting the third control signal comprising a non-stationary signal and a stationary signal, for which the second clock signal is received by a status control unit; and
outputting selectively the first clock signal or the second clock signal in accordance with the third control signal, for which the first clock signal and the second clock signal are received by a multiplexer;
wherein a vibration-generating velocity of the first oscillating module is faster than that of the second oscillating module, and a frequency error of the first clock signal is larger than that of the second clock signal.

15. The clock generating method as claimed in claim 14, wherein a frequency of the first clock signal is larger than or equal to 80 percent of a frequency of the second clock signal, and is less than or equal to 120 percent of the frequency of the second clock signal.

16. The clock generating method as claimed in claim 14, wherein the frequency of the first clock signal is equal to the frequency of the second clock signal.

17. A control method of a clock generating circuit with a control unit, comprising:
entering a halt mode when a halt signal received by the control unit for outputting a first control signal with a disable status and a second control signal with a disable status, so as to let a third control signal to be a non-stationary signal;
entering a vibration-generating mode when a wake-up signal is received by the control unit for outputting the first control signal with the enable status and the second control signal with the enable status, so as to let the third control signal to be a non-stationary signal; and
entering a stabilization mode, and meanwhile, the third control signal being the stationary signal for outputting the first control signal with the disable status and the second control signal with the enable status.
